(19) United States
(12) Patent Application Publication
(10) Pub. No.: US 2020/0356505 A1
(43) Pub. Date: Nov. 12, 2020

(54) MULTIPLE MASTERS CONNECTING TO A SINGLE SLAVE IN AN AUDIO SYSTEM

(71) Applicant: QUALCOMM Incorporated, San Diego, CA (US)

(72) Inventors: Lior Amarilio, Yokneam (IL); Ghanashyam Prabhu, Bangalore (IN); Mohammed Shadab Ansari, Bangalore (IN)

(21) Appl. No.: 16/405,551

(22) Filed: May 7, 2019

(51) Int. Cl. G06F 13/38

(52) U.S. Cl. CPC G06F 13/38; G06F 2213/40

(57) ABSTRACT

Multiple masters connecting to a single slave in an audio system designate a primary master between the multiple masters. Clock signals from secondary masters are turned off. In a first exemplary aspect, data signals from the secondary masters are still provided over distinct data lines to the slave. In a second exemplary aspect, data signals from the secondary masters are multiplexed onto a single data line of the primary master.

### BACKGROUND

### I. Field of the Disclosure

The technology of the disclosure relates generally to audio buses having multiple masters and particularly to SOUNDWIRE audio buses having multiple masters.

### II. Background

Mobile communication devices have become increasingly common in current society. The prevalence of these mobile communication devices is driven in part by the many functions that are now enabled on such devices. Increased processing capabilities in such devices means that mobile communication devices have evolved from pure communication tools into sophisticated mobile entertainment centers, thus enabling enhanced user experiences.

The mobile communication devices commonly include at least one microphone and multiple speakers. The microphone and the speakers used in the mobile communication devices typically have analog interfaces which require a dedicated two-wire connection between each pair of devices. Since a mobile communication device is capable of supporting multiple audio devices, it may be desirable to allow a microprocessor or other control device in the mobile communication device to communicate audio data to multiple audio devices over a common communication bus simultaneously.

In this regard, the MIPI® Alliance initially developed the Serial Low-power Inter-chip Media Bus (SLIMbus℠ or SLIMBUS) to handle audio signals within a mobile communication device. The first release was published in October 2005 with v1.01 released on Dec. 3, 2008. In response to industry feedback, MIPI has also developed SoundWire℠ (SOUNDWIRE), a communication protocol for a processor in the mobile communication device (the “master”) to control distribution of digital audio streams between one or more audio devices (the “slave(s)”) via one or more SOUNDWIRE slave data ports. Version 1 was released on Jan. 21, 2015.

There are situations where there may be multiple masters in an audio system that couple to a single slave. For example, a first master may control microphones and speakers of a headset for voice communication such as a phone call while a second master may monitor a microphone in the headset for an always-on listening program such as the APPLE SIRI application or the AMAZON ALEXA application. In the past, the two masters may operate at different clock rates and require separate audio buses. Such duplication of buses increases the requirements for the peripheral and may otherwise be inefficient. Accordingly, a more efficient arrangement may provide cost savings and greater flexibility.

### SUMMARY OF TIE DISCLOSURE

Aspects disclosed in the detailed description include multiple masters connecting to a single slave in an audio system. In particular, exemplary aspects of the present disclosure designate a primary master between the multiple masters. Clock signals from secondary masters are turned off. In a first exemplary aspect, data signals from the secondary masters are still provided over at least one distinct data line to the slave. In a second exemplary aspect, data signals from the secondary masters are multiplexed onto a single data line of the primary master. By eliminating a second clock line and potentially combining data lines, pin counts may be reduced resulting in cost savings therefrom. Additionally, the peripheral to which the data line(s) is coupled may be simplified through elimination of duplicative hardware, resulting in further cost savings for such peripherals.

In this regard in one aspect, an apparatus for controlling an audio bus including a device is disclosed. The apparatus includes an audio bus interface including a clock output and at least one data lane output. The apparatus also includes a first audio master core coupled to the audio bus interface and a clock source. The apparatus also includes a second audio master core coupled to the first audio master core through a link.

In another aspect, a method for providing signals from multiple audio master cores to a single audio slave core is disclosed. The method includes providing a first master core. The method also includes providing a second master core. The method also includes providing a link between the first master core and the second master core. The method also includes designating the first master core as a primary master core and the second master core a secondary master core.

### BRIEF DESCRIPTION OF THE FIGURES

FIG. 1 is a block diagram of a conventional exemplary SOUNDWIRE audio system;

FIG. 2 is a block diagram of a conventional exemplary SOUNDWIRE audio system with multiple masters coupled to a single slave peripheral;

FIG. 3 is a block diagram of a first exemplary SOUNDWIRE audio system according to the present disclosure with a shared clock line and separate data lines;

FIG. 4 is a block diagram of a second exemplary SOUNDWIRE audio system according to the present disclosure with a shared clock line and a shared data line;

FIG. 5 is a flowchart illustrating an exemplary process for selecting a primary master amongst a plurality of masters in an audio system;

FIG. 6A is a flowchart illustrating an exemplary process of a primary master controlling one or more secondary masters in an audio system;

FIG. 6B is a time line of frames in an audio system where the subordinate masters signify readiness for changes imposed by a primary master; and

FIGS. 7A-7C are block diagrams of exemplary processor-based systems that can include the audio systems of FIGS. 3 and 4.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include multiple masters connecting to a single slave in an audio system. In particular, exemplary aspects of the present disclosure designate a primary master between the multiple masters. Clock signals from secondary masters are turned off. In a first exemplary aspect, data signals from the secondary masters are still provided over at least one distinct data line to the slave. In a second exemplary aspect, data signals from the secondary masters are multiplexed onto a single data line of the primary master. By eliminating a second clock line and potentially combining data lines, pin counts may be reduced resulting in cost savings therefrom. Additionally, the peripheral to which the data line(s) is coupled may be simplified through elimination of duplicative hardware, resulting in further cost savings for such peripherals.

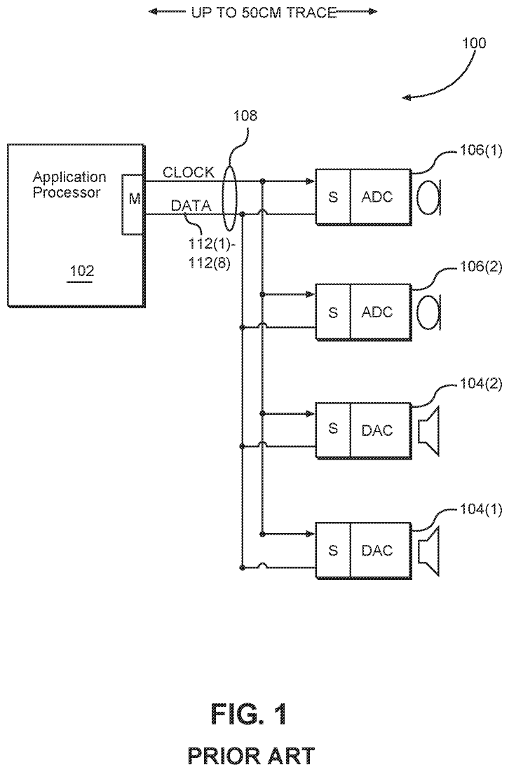

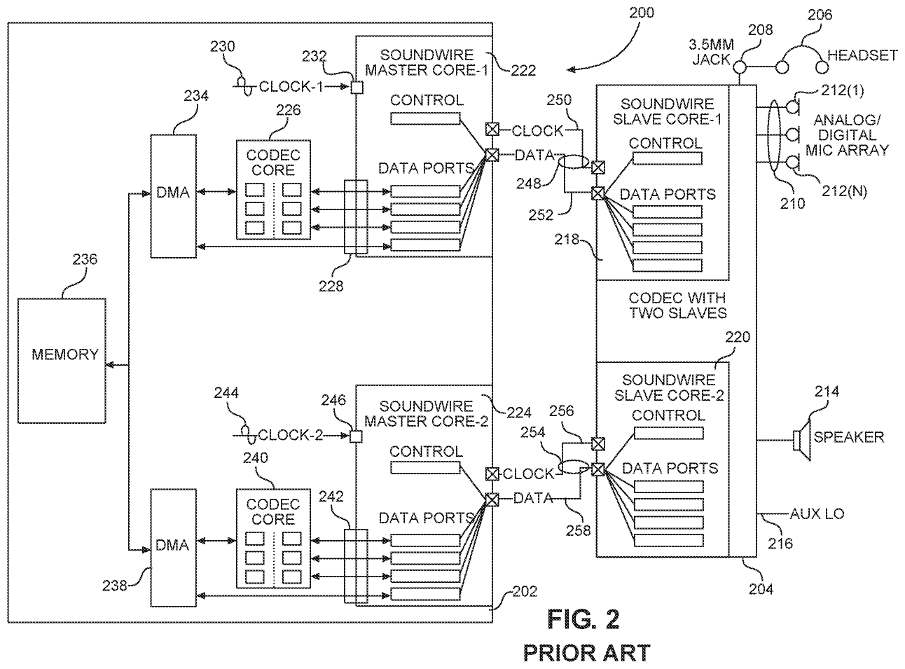

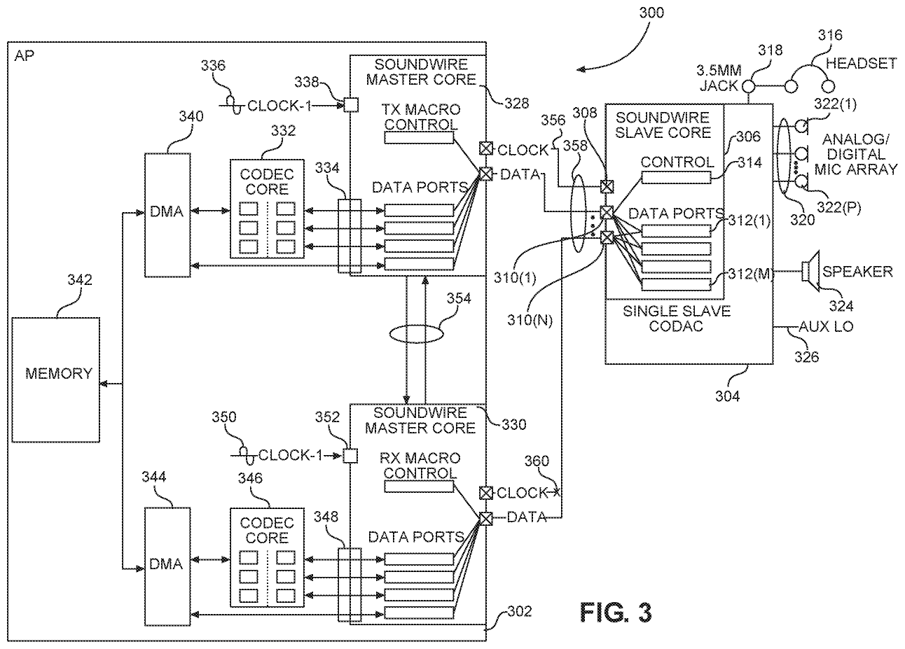

Before addressing particular aspects of the present disclosure, a brief overview of a SOUNDWIRE audio system is provided with reference to FIG. 1. FIG. 2 illustrates a conventional approach to connecting two masters to a single slave. Against this backdrop, a discussion of exemplary aspects of the present disclosure begins below with reference to FIG. 3.

In this regard, FIG. 1 is block diagram of an exemplary SOUNDWIRE system 100. The SOUNDWIRE system 100 includes an application processor 102 coupled to a plurality of microphones 104(1)-104(2) and a plurality of speakers 106(1)-106(2) by a multi-wire bus 108. The multi-wire bus 108 includes a clock line 110 and one or more (up to eight) data lines 112(1)-112(8). The application processor 102 is generally regarded as a master or audio bus master of the SOUNDWIRE system 100, and the plurality of microphones 104(1)-104(2) and each of the plurality of speakers 106(1)-106(2) (as well as any other audio components) are slaves. While illustrated as the application processor 102, it should be appreciated that the application processor 102 could be replaced by a codec (not illustrated) or the like. The multi-wire bus 108 is limited by the SOUNDWIRE specification to less than 50 centimeters (cm). More information on the SOUNDWIRE specification may be found at Specification for SOUNDWIRE, version 1, released on Jan. 21, 2015, available at members.mipi.org/wg/LML/document/folder/8154 to MIPI members. The SOUNDWIRE specification is incorporated by reference in its entirety.

The SOUNDWIRE specification defines a fixed frame having multiple lanes (up to eight), In practice, each lane is assigned to one of the one or more data lines 112(1)-112(8) of the multi-wire bus 108. The frame has rows and columns. In each row, bit slots are provided that may change from any source to any other source.

In the past, there may be situations where a single slave peripheral, such as a codec, may be coupled to multiple masters. Frequently, the solution to this situation was two full audio buses. This situation is illustrated in FIG. 2. In this regard, FIG. 2 illustrates an audio system 200 including an application processor 202 and a codec 204. The codec 204 may be coupled to: a headset 206 through an audio jack 208; a microphone array 210 having microphones 212(1)-212(N) therein; a speaker 214; and/or an auxiliary line out (LO) 216. The codec 204 has a first SOUNDWIRE slave core 218 that may, for example, control the audio connection to the headset 206 including any microphones and speakers therein. The codec 204 has a second SOUNDWIRE slave core 220 that may, for example, control the microphone array 210 and the speaker 214 with the primary activity being monitoring the microphone array 210 for spoken key words that trigger activity for an always-on listening application (e.g., SIRI or ALEXA).

With continued reference to FIG. 2, the application processor 202 may have a first SOUNDWIRE master core 222 and a second SOUNDWIRE master core 224. The first SOUNDWIRE master core 222 may be coupled to a first codec core 226 through an interface 228 and receive a first clock signal 230 through a clock input 232. The first SOUNDWIRE master core 222 and the first codec core 226 may be coupled to a first direct memory access (DMA) circuit 234, which in turn is coupled to a memory, circuit 236. The memory circuit 236 may also be coupled to a second DMA circuit 238, which is coupled to a second codec core 240 and the second SOUNDWIRE master core 224. The second codec core 240 may be coupled to the second SOUNDWIRE master core 224 through an interface 242. The second SOUNDWIRE master core 224 may also receive a second clock signal 244 through a clock input 246. It should be appreciated that the clock signals 230 and 244 may not be at the same clock rate.

In practice, the first SOUNDWIRE master core 222 communicates with the first SOUNDWIRE slave core 218 through a first SOUNDWIRE bus 248 having a first clock line 250 and one or more data lines 252. Similarly, the second SOUNDWIRE master core 224 communicates with the second SOUNDWIRE slave core 220 through a second SOUNDWIRE bus 254 having a second clock line 256 and one or more data lines 258. This arrangement leads to duplicative clock lines and data lines and requires more pins at both the application processor 202 and the codec 204. Such duplicative lines and pins may increase the cost of the component. Consequently, some peripheral manufacturers wish to reduce costs of the peripherals by consolidating cores in the peripheral. However, the different functions may still need different masters in the application processor.

Exemplary aspects of the present disclosure allow one of the master cores to assume primacy over others of the master cores to coordinate communication to the external circuit. This coordination allows potential elimination of duplicative clock lines and/or consolidation of data lines. The reduction in lines being connected to the external circuit may reduce pin counts as well as reduce routing requirements for the lines. Accordingly, cost savings may be achieved by such consolidation. It should be appreciated that while only two masters are discussed, the present disclosure may be extended to more than two masters, with one master assuming the primary role and all other masters assuming subordinate roles as outlined below.

In this regard, FIG. 3 illustrates a computing system 300 having an application processor (sometimes referred to as an AP or a system on a chip (SoC)) 302 coupled to a peripheral 304, which may be a codec in a peripheral device. The peripheral 304 may include a single slave core 306 with a clock input 308 and plural data inputs 310(1)-310(N). As illustrated, N is two (2), but more data inputs may be present. The data inputs 310(1)-310(N) map to plural data ports 312(1)-312(M) and a control circuit 314 in the slave core 306. The peripheral 304 may be coupled to: a headset 316 through an audio jack 318; a microphone array 320 having microphones 322(1)-322(P) therein; a speaker 324; and/or an auxiliary line out (LO) 326.

With continued reference to FIG. 3, the application processor 302 may have a first SOUNDWIRE master core 328 (generically a first audio master core) and a second SOUNDWIRE master core 330 (generically a second audio master core). The first SOUNDWIRE master core 328 includes an audio bus interface (not shown explicitly) configured to be coupled to a SOUNDWIRE bus 358. The audio bus interface may include a clock output (labeled CLOCK) and at least one data lane output (labeled DATA), Within the application processor 302, the first SOUNDWIRE master core 328 may be coupled to a first codec core 332 through an interface 334 and receive a first clock signal 336 through a clock input 338. The first SOUNDWIRE master core 328 and the first codec core 332 may be coupled to a first DMA circuit 340, which in turn is coupled to a memory circuit 342. The memory circuit 342 may also be coupled to a second DMA circuit 344, which is coupled to a second codec core 346 and the second SOUNDWIRE master core 330. The second codec core 346 may be coupled to the second SOUNDWIRE master core 330 through an interface 348. The second SOUNDWIRE master core 330 may also receive a second clock signal 350 through a clock input 352. It should be appreciated that the clock signals 336 and 350 are the same (e.g., “clock-1”) because they come from the same source (not shown, but for example, an off-chip crystal oscillator, a phase-locked loop (PLL) clock source within the application processor 302, or the like). In practice, the clock signals 336 and 350 should have minimal skew (e.g., less than 10 nanoseconds and less than or equal to 5 nanoseconds in an exemplary aspect). In the event that the first SOUNDWIRE master core 328 and the second SOUNDWIRE master core 330 include clock dividers (not shown), these dividers will be set so that they generate identical bus clock frequencies (e.g., CLOCK) so that the data from the different cores may operate on the SOUNDWIRE bus 358 at CLOCK. The second SOUNDWIRE master core 330 includes an audio bus interface (not shown explicitly) configured to be coupled to the SOUNDWIRE bus 358. The audio bus interface may include a clock output (labeled CLOCK) and at least one data lane output (labeled DATA, also sometimes referred to as a second data lane output).

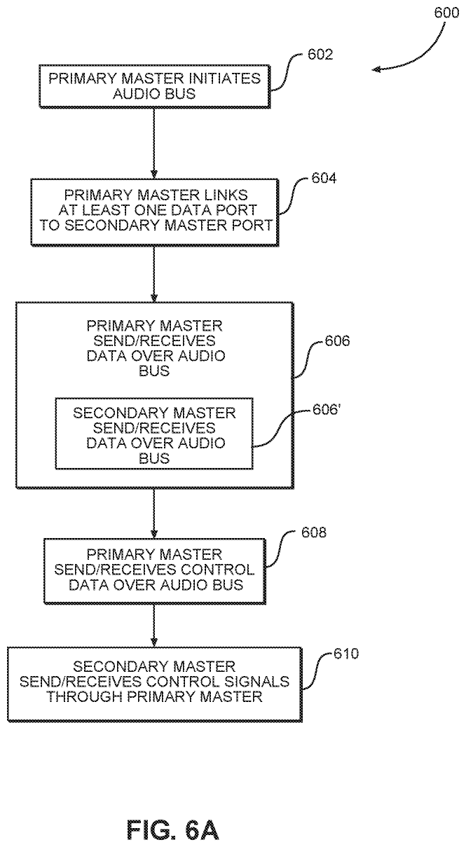

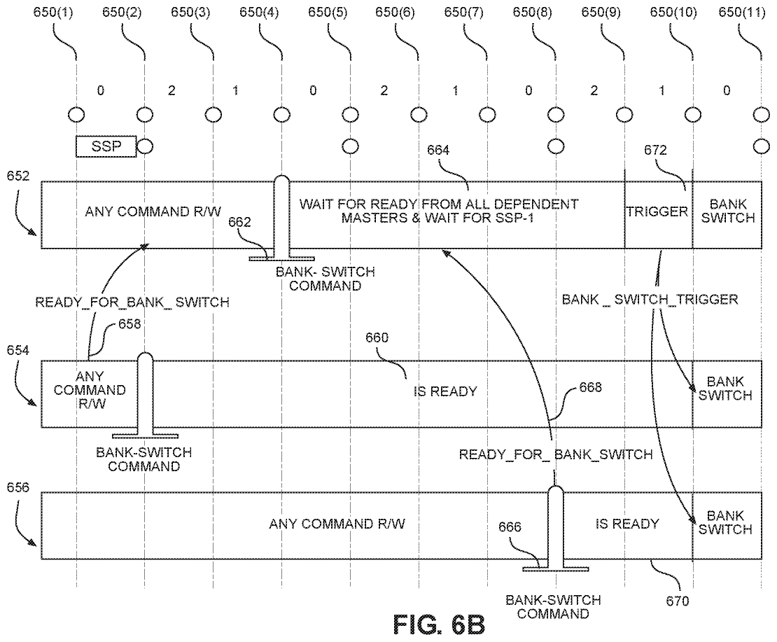

To facilitate operation, the first SOUNDWIRE master core 328 communicates with the second SOUNDWIRE master core 330 through a link 354, which may be internal conductive traces in the metal layers of the integrated circuit (IC) or chip containing the application processor 302. The protocol used over the link 354 may be any acceptable signaling protocol. The link 354 may be part of a system bus for the application processor 302 as needed or desired. Because the peripheral 304 has only one slave core 306, only the one clock input 308 is present. Accordingly, only one clock line 356 is provided in the SOUNDWIRE: bus 358. The SOUNDWIRE specification allows for up to eight data lines, and thus, the data line(s) from the first SOUNDWIRE master core 328 and the data line(s) from the second SOUNDWIRE master core 330 may be combined into a single bus 358. Since the clock rates from the two SOUNDWIRE master cores 328, 330 are forced to be the same, the second SOUNDWIRE master core 330 does not have to provide a clock signal to the bus 358 (generally indicated at the “x” 360 for the clock output). Likewise, any control signals that the second SOUNDWIRE master core 330 would send are provided to the slave core 306 through the first SOUNDWIRE master core 328 via the link 354. That is, in all multi-master configurations, the primary master (e.g., the first SOUNDWIRE master core 328) is responsible for and owns the generation and management of the control channel (Control-Ch) assigned on bit slots 0-47 of the first column of a frame. Conversely, any secondary master is not generating, nor is it required to observe any control channel bit slots. Individual data ports may be assigned to any of the available data lines, and all the masters are synchronized to the same bank-switch event. The general concept of a bank-switch event is defined in the SOUNDWIRE specification and is understood although currently the SOUNDWIRE specification does not contemplate two or more masters being synchronized to a single bank-switch event as provided herein. More detail on this synchronization is provided below with reference to FIG. 6B.

Note that it is expected that the secondary SOUNDWIRE master core 330 will not have any control over the control channel. In this specific connection topology where Data-Lane® (e.g., the first data lane) is coming from the primary SOUNDWIRE master core 328 and Data-Lane1 (e.g., the second data lane) is coming from the secondary SOUNDWIRE master core 330, it is permitted for the secondary SOUNDWIRE master core 330 to own part of or all of the control bit slots if this simplifies implementation. As with all engineering decisions, the tradeoff for this flexibility is made at the expense of allocating space in the payload audio channel and lowering the possible overall bandwidth. In the event that the secondary SOUNDWIRE master core 330 has this functionality, the secondary SOUNDWIRE master core 330 shall ignore any response from the slave on the fields of the control channel of Data-Lane0.

While only two master cores are shown in FIG. 3, it again should be appreciated that the present disclosure may be extended to more than two master cores without departing from the scope of the present disclosure.

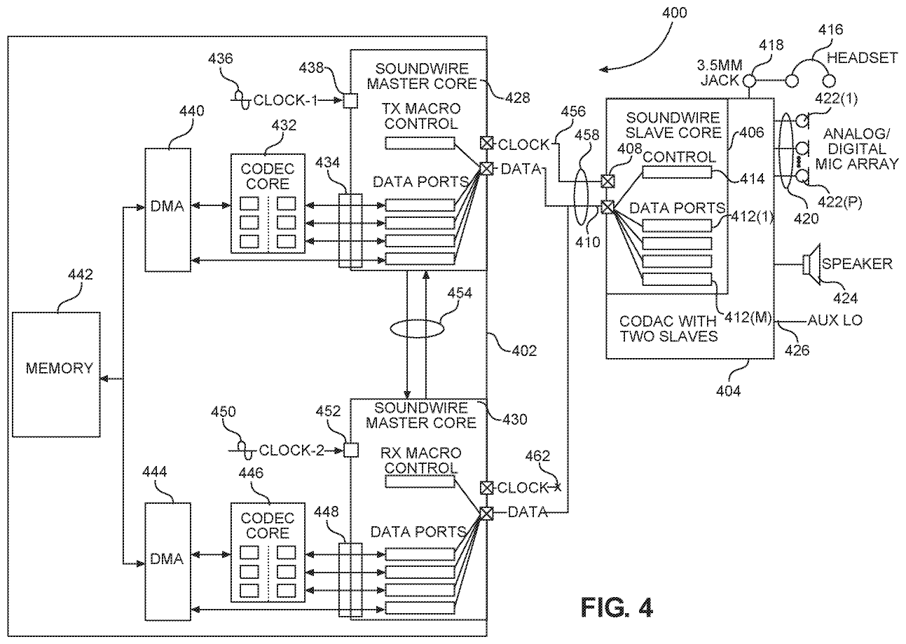

As an alternative to the computing system 300 of FIG. 3 with the single bus 358, it is possible to multiplex the data from the various masters onto a single data line. FIG. 4 illustrates a computing system 400 where such multiplexing takes place. In this regard, FIG. 4 illustrates a computing system 400 having an application processor (sometimes referred to as an AP or a system on a chip (SoC)) 402 coupled to a peripheral 404, which may be a codec in a peripheral device. The peripheral 404 may include a single slave core 406 with a clock input 408 and a single data input 410. The data input 410 maps to plural data ports 412(1)-412(M) and a control circuit 414 in the slave core 406. The peripheral 404 may be coupled to: a headset 416 through an audio jack 418; a microphone array 420 having microphones 422(1)-422(P) therein; a speaker 424; and/or an auxiliary line out (LO) 426.

With continued reference to FIG. 4, the application processor 402 may have a first SOUNDWIRE master core 428 (generically a first audio master core) and a second SOUNDWIRE master core 430 (generically a second audio master core). The first SOUNDWIRE master core 428 includes an audio bus interface (not shown explicitly) configured to be coupled to a SOUNDWIRE bus 458. The audio bus interface may include a clock output (labeled CLOCK) and an at least one data lane output (labeled DATA). Within the application processor 302, the first SOUNDWIRE master core 428 may be coupled to a first codec core 432 through an interface 434 and receive a first clock signal 436 through a clock input 438. The first SOUNDWIRE master core 428 and the first codec core 432 may be coupled to a first DMA circuit 440, which in turn is coupled to a memory circuit 442. The memory circuit 442 may also be coupled to a second DMA circuit 444, which is coupled to a second codec core 446 and the second SOUNDWIRE master core 430. The second codec core 446 may be coupled to the second SOUNDWIRE master core 430 through an interface 448. The second SOUNDWIRE master core 430 may also receive a second clock signal 450 through a clock input 452. It should be appreciated that the clock signals 436 and 450 are the same (e.g., “clock-1”) as described above with reference to FIG. 3. The second SOUNDWIRE master core 430 includes an audio bus interface (not shown explicitly) configured to be coupled to the SOUNDWIRE bus 458. The audio bus interface may include a clock output (labeled CLOCK) and an at least one data lane output (labeled DATA, also sometimes referred to as a second data lane output). It should be appreciated that the second SOUNDWIRE master core 430 is not exporting any control channel signals, and all the control channel bit slots are owned by and generated by the primary SOUNDWIRE master core 428.

To facilitate operation, the first SOUNDWIRE master core 428 communicates with the second SOUNDWIRE master core 430 through a link 454, which may be internal conductive traces in the metal layers of the IC or chip containing the application processor 402. The protocol used over the link 454 may be any acceptable signaling protocol. The link 454 may be part of a system bus for the application processor 402 as needed or desired. Because the peripheral 404 has only one slave core 406, only the one clock input 408 is present. Accordingly, only one clock line 456 is provided in the SOUNDWIRE bus 458. The SOUNDWIRE specification allows for up to eight data lines, but if the peripheral 404 only has a single data input 410, the data line(s) from the first SOUNDWIRE master core 428 and the data line(s) from the second SOUNDWIRE master core 430 may be multiplexed into the single data input 410 on the bus 458. Since the clock rates are forced to be the same, the second SOUNDWIRE master core 430 does not have to provide a clock signal to the bus 458 (generally indicated at the “x” 462). Likewise, any control signals that the second SOUNDWIRE master core 430 would send are provided to the slave core 406 through the first SOUNDWIRE master core 428 via the link 454. It should be appreciated that the multiplexing may be internal to the application processor 402 or external thereto.

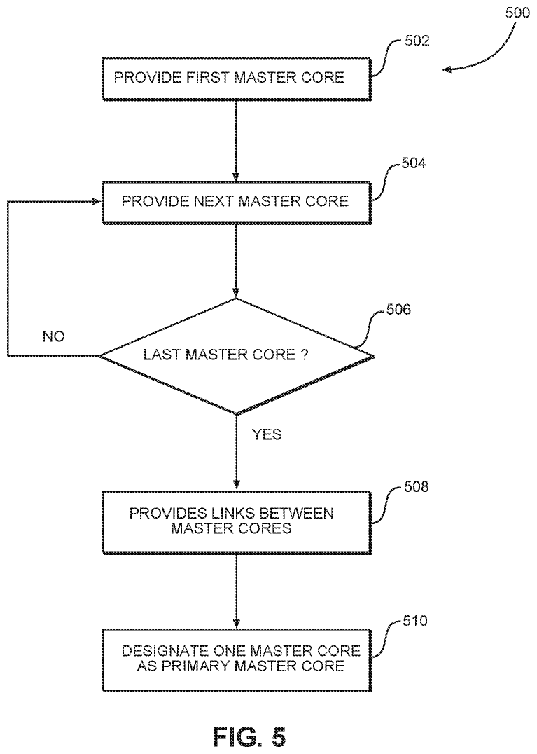

FIG. 5 provides a flowchart of a process 500 for designating one of the master cores as a primary master core. In this regard, the process 500 begins by, providing a first master core (block 502) in an IC. The process 500 continues by providing a next master core (block 504) in the IC. The process 500 determines if this is the last master core to be added (block 506). If the answer is no, then the process 500 iterates until the answer is yes at block 506. Note that this circuit design may be done manually or through software including pick and place and route software as is well understood. The process 500 continues by providing links between the master cores (block 508). As noted above, these links may be traces in the metal layers of the IC or the like. The circuit designer then may designate one master core as the primary master core (block 510), This designation may be hardwired into the IC, set by a software driver, denoted through a jumper, or the like. Instead of the circuit designer, the designation may be made randomly by a contention process or the like. Note that the software driver may further configure the frame shape and the stream synchronization point (SSP) for all masters associated with the bus. The software driver may further initiate the synchronization process as outlined below.

FIG. 6A provides a flowchart of a process 600 illustrating the multiple masters connecting to a single slave in an audio system in use. In this regard, the process 600 begins with a primary master initializing the audio bus (block 602). The SOUNDWIRE specification provides rules for how this is done, and the actual steps are well understood. The primary master then links at least one data port for at least one audio channel to the secondary master (block 604). The primary master sends/receives data over the audio bus (block 606). Note that if the secondary master has its own data line, the secondary master may also send/receive data over the audio bus (block 606′). The primary master sends/receives control signals over the audio bus (block 608), The secondary master(s) sends/receives control signals through the primary master (block 610). To make sure that the primary master and any secondary masters are properly, aligned, the present disclosure implements a shared synchronization process. In this regard, FIG. 6B illustrates internal states of three masters over several frames. The time line reflects a state where any command can be a read or write to any one of the masters from a software entity that causes configuration of the non-active bank registers at the slave. Following each such command, a bank switch command is written to each one of the masters. The commands may reach slaves at different times since the software is not synchronized to the hardware operation. Accordingly, each secondary master indicates when it is ready to perform a bank switch by asserting an IS_READY indication to the primary master. The primary master generates a Trigger event to all masters at an SSP time only when a bank switch command was written to it by the software and all secondary masters (in this case 2) indicate IS_READY. By imposing these requirements, all bank switch operations will take effect at the same moment across all data ports and all masters.

In particular, FIG. 6B illustrates this bank switch process. Each vertical line 650(1)-650(11) represents a frame. For the sake of example, each SSP is associated with three frames. To get the desired synchronization, the primary master 652 waits for all the auxiliary masters 654, 656 to assert IS_READY. As illustrated in the example, the auxiliary master 654 indicates a ready state at 658 and enters a ready state 660. The primary master 652 provides a bank switch command 662, but does not trigger the bank switch because not all the auxiliary masters 654, 656 have indicated a ready state. Thus, the primary master 652 waits for the ready state from the auxiliary masters (generally indicated at 664). Eventually, the auxiliary master 656 provides bank switch command 666 and indicates a ready state 668 before entering a ready state 670. After receipt of the ready indication from the auxiliary masters 654, 656, the primary master 652 issues a trigger command 672 in frame 650(9) and all masters execute the bank switch at frame 650(10).

Note that the use of the “/” herein indicates and/or.

The multiple masters connecting to a single slave in an audio system according to aspects disclosed herein may be provided in or integrated into any, processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

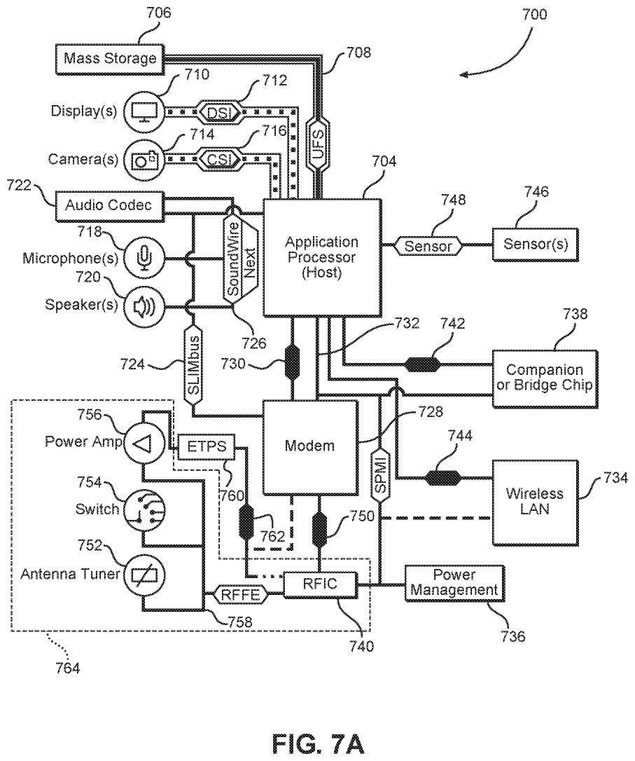

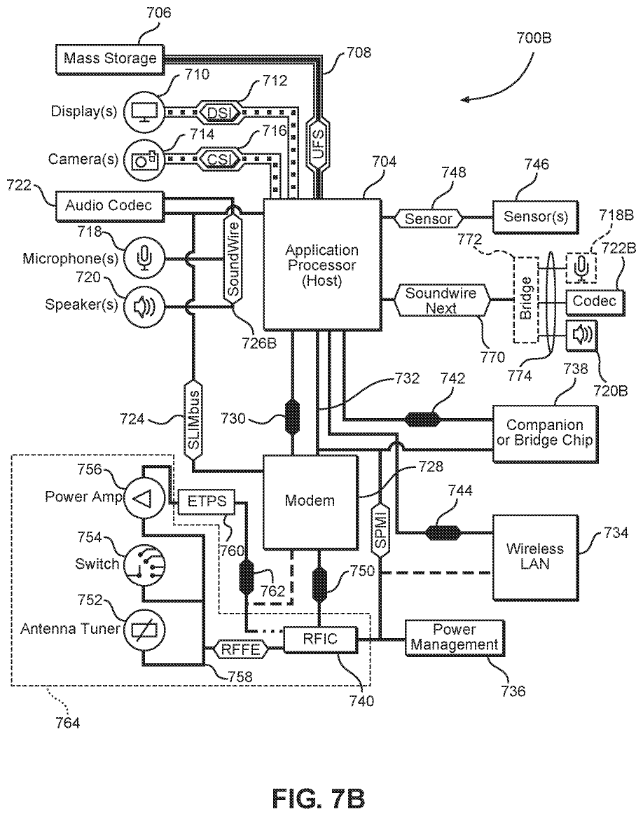

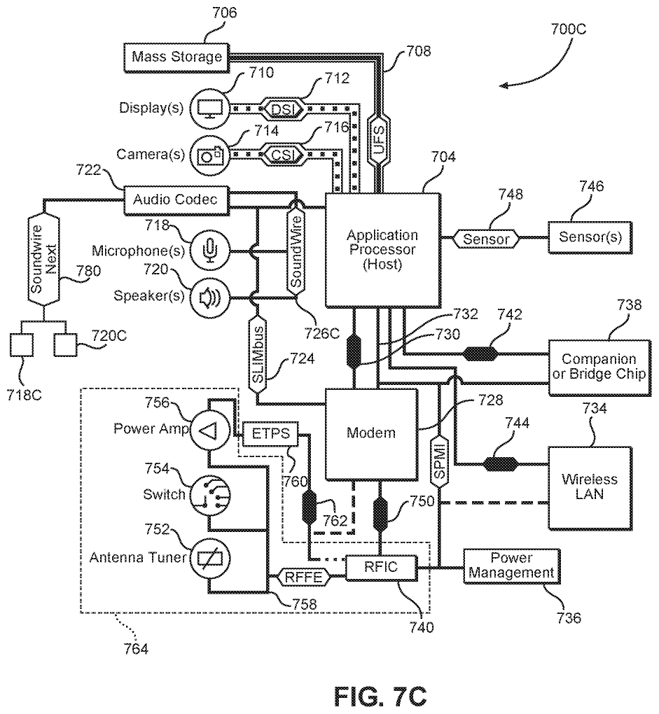

Exemplary aspects of the present disclosure are well suited for use with a SOUNDWIRE bus. There are a variety of locations in a computing device at which a SOUNDWIRE bus may be placed. In this regard, FIGS. 7A-7C illustrate various placements. In most instances, the overall architecture is the same. In this regard, FIG. 7A is system-level block diagram of an exemplary mobile terminal 700 such as a smart phone, mobile computing device tablet, or the like. While a mobile terminal is particularly contemplated as being capable of benefiting from exemplary aspects of the present disclosure, it should be appreciated that the present disclosure is not so limited and may be useful in any system having a SOUNDWIRE audio bus.

With continued reference to FIG. 7A, the mobile terminal 700 includes an application processor 704 (sometimes referred to as a host) that communicates with a mass storage element 706 through a universal flash storage (UFS) bus 708. The application processor 704 may further be connected to a display 710 through a display serial interface (DSI) bus 712 and a camera 714 through a camera serial interface (CSI) bus 716. Various audio elements such as a microphone 718, a speaker 720, and an audio codec 722 may be coupled to the application processor 704 through a serial low power interchip multimedia bus (SLIMbus) 724. Additionally, the audio elements may communicate with each other and the audio codec 722 through the SOUNDWIRE bus 726. A modem 728 may also be coupled to the SUMbus 724. The modern 728 may further be connected to the application processor 704 through a peripheral component interconnect (PCI) or PCI express (PCIe) bus 730 and/or a system power management interface (SPMI) bus 732. Note that the SLIMbus 724 may be replaced by a SOUNDWIRE bus in some implementations.

With continued reference to FIG. 7A, the SPMI bus 732 may also be coupled to a wireless local area network (WLAN) integrated circuit (IC) (WLAN IC) 734, a power management integrated circuit (PMIC) 736, a companion integrated circuit (sometimes referred to as a bridge chip) 738, and a radio frequency integrated circuit (WIC) 740. It should be appreciated that separate PCI buses 742 and 744 may also couple the application processor 704 to the companion integrated circuit 738 and the WLAN IC 734. The application processor 704 may further be connected to sensors 746 through a sensor bus 748. The modem 728 and the RFIC 740 may communicate using a bus 750.

With continued reference to FIG. 7A, the RFIC 740 may couple to one or more radio frequency front end (RFFE) elements, such as an antenna tuner 752, a switch 754, and a power amplifier 756 through an RFFE bus 758. Additionally, the RFIC 740 may couple to an envelope tracking power supply (ETPS) 760 through a bus 762, and the ETPS 760 may communicate with the power amplifier 756. Collectively, the RFFE elements, including the RFIC 740, may be considered an RFFE system 764.

FIG. 7B illustrates an alternate placement of the SOUNDWIRE bus. While the majority of the elements are the same as the mobile terminal 700, the mobile terminal 700B illustrated in FIG. 7B has a SOUNDWIRE bus 726B coupling the audio codec 722 to the microphone(s) 718 and the speaker(s) 720. The application processor 704 may be coupled to a SOUNDWIRE bus 770 that may couple to an optional bridge 772. If the bridge 772 is present, then the bus 774 may be a SOUNDWIRE bus. If the bridge 772 is not present, then the SOUNDWIRE bus 770 may couple directly to microphones 718B, speakers 720B, and/or an audio codec 722B.

Similarly, FIG. 7C illustrates another alternate placement of the SOUNDWIRE bus. In the mobile terminal 700C, the audio codec 722 may couple to a SOUNDWIRE bus 726C and a SOUNDWIRE bus 780. The SOUNDWIRE bus 780 may couple to microphones 7180 and speakers 720C.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices and slave devices described herein may be employed in any circuit, hardware component, IC, or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded widest scope consistent with the principles and features disclosed herein.

1. An apparatus for controlling an audio bus, comprising:
an integrated circuit (IC) comprising:
an audio bus interface comprising a clock output and at least one data lane output;
a first audio master core coupled to the audio bus interface and a clock source; and
a second audio master core coupled to the first audio master core through a link,
wherein the second audio master core is configured to pass control signals for a slave on the audio bus through the first audio master core.

2. The apparatus of claim 1, wherein the audio bus interface comprises a SOUNDWIRE audio bus interface.

3. The apparatus of claim 1, wherein the second audio master core is coupled to the clock source.

4. The apparatus of claim 1, wherein the second audio master core is coupled to a second data lane output.

5. The apparatus of claim 1, wherein the second audio master core is coupled to the at least one data lane output.

6. The apparatus of claim 1, wherein the second audio master core is configured to pass the control signals to the first audio master core through the link.

7. The apparatus of claim 1, wherein the first audio master core provides an only clock signal to the audio bus.

8. The apparatus of claim 1, wherein the IC comprises an application processor, the application processor comprising the first audio master core, the second audio master core, and the audio bus interface.

9. The apparatus of claim 1, further comprising a first codec core coupled to the first audio master core.

10. The apparatus of claim 9, further comprising a second codec core coupled to the second audio master core.

11. The apparatus of claim 1, further comprising a memory circuit coupled to the first audio master core through a direct memory access (DMA) circuit.

12. (canceled)

13. The apparatus of claim 1 wherein the apparatus is integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

14. A method for providing signals from multiple audio master cores to a single audio slave core, comprising:
providing a first audio master core in an integrated circuit (IC);
providing a second audio master core in the IC;
providing a link between the first audio master core and the second audio master core, wherein the link is contained within the IC; and
designating the first audio master core as a primary master core and the second audio master core as a secondary master core, wherein the second audio master core is configured to pass control signals for the single audio slave core on an audio bus through the first audio master core.

15. The method of claim 14, further comprising sending first data from the first audio master core to the single audio slave core on the audio bus.

16. The method of claim 15, further comprising sending second data from the second audio master core to the single audio slave core on the audio bus.

17. The method of claim 15, wherein sending the first data on the audio bus comprises sending the first data on a SOUNDWIRE bus.

18. The method of claim 16, wherein sending the second data on the audio bus comprises allocating a lane on the audio bus to the second data.

19. The method of claim 16, wherein sending the first data and the second data on the audio bus comprises multiplexing the first data and the second data into a single lane on the audio bus.

20. The method of claim 19, further comprising sending the control signals from the second audio master core to the first audio master core.
